(19) United States
(12) Patent Application Publication
(10) Pub. No.: US 2025/0282650 A1
(43) Pub. Date: Sep. 11, 2025

(54) METHOD FOR REDUCING RISK OF ULTRA-SHORT CHAIN PER- AND POLYFLUOROALKYL SUBSTANCES IN WATER

(71) Applicant: Nanjing University, Nanjing (CN)

(72) Inventors: Haidong HU, Nanjing (CN); Yuanji SHI, Nanjing (CN); Jiaqian YOU, Nanjing (CN); Hongqiang REN, Nanjing (CN)

(21) Appl. No.: 18/797,478

(22) Filed: Aug. 7, 2024

(30) Foreign Application Priority Data
Mar. 6, 2024 (CN) 202410252327.1

(51) Int. Cl. C02F 1/28; C02F 101/36; C02F 103/00

(52) U.S. Cl. CPC C02F 1/281; C02F 2101/36; C02F 2103/007

(57) ABSTRACT

A method for removing risk of ultra-short chain per- and polyfluoroalkyl substances (PFASs) in water including: measuring concentrations of long-chain per- and polyfluoroalkyl substances (PFASs), short-chain PFASs, and ultra-short-chain PFASs separately in target water; calculating a first ratio and a second ratio; and selecting, based on the first ratio and the second ratio, Beta zeolite with a silicon-to-aluminum ratio; where, the first ratio is a ratio of a concentration of the long-chain PFASs to a combined concentration of the short-chain PFASs and the ultra-short-chain PFASs; and the second ratio is a ratio of the concentration of the short-chain PFASs to the concentration of the ultra-short-chain PFASs; and cyclically adsorbing and removing, using the selected Beta zeolite, the ultra-short-chain PFASs from the target water.

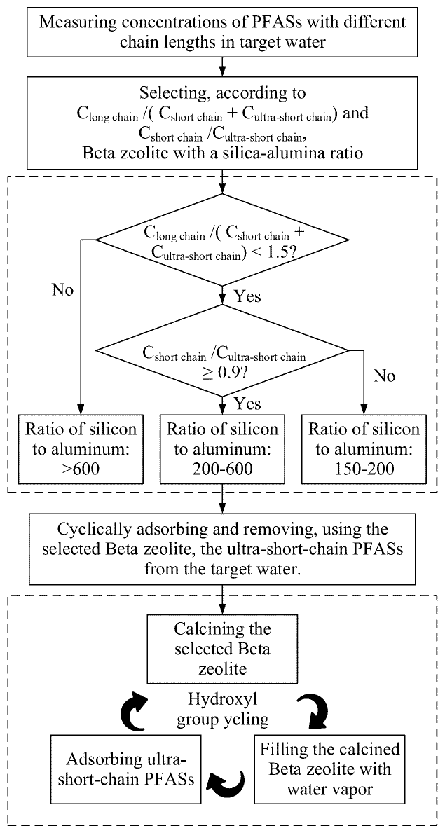

### CROSS-REFERENCE TO RELATED APPLICATIONS

Pursuant to 35 U.S.C. § 119 and the Paris Convention Treaty, this application claims foreign priority to Chinese Patent Application No. 202410252327.1 filed Mar. 6, 2024, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, MA 02142.

### BACKGROUND

The disclosure relates to a method for reducing risk of ultra-short chain per- and polyfluoroalkyl substances (PFASs) in water.

Per- and polyfluoroalkyl substances are a class of fluorinated organic compounds where some or all hydrogen atoms on the alkyl carbon chain are replaced by fluorine. The substitution results in PFASs being highly stable both chemically and thermally, leading to their widespread use in various industrial and commercial applications. However, the properties that makes PFASs useful also cause them to persist in the environment, remain mobile in water, and bioaccumulate in living organisms. The environmental persistence has raised significant concerns, particularly regarding the potential for PFASs to exceed safe limits in ecosystems. Recognizing the risks, the Stockholm Convention in 2009 and 2017 prohibited the production and use of long-chain PFASs (with chain lengths of greater than 7, such as perfluorooctanoic acid (PFOA) and perfluorooctanesulfonic acid (PFOS)). In response, homologues of short-chain PFASs (with chain lengths of 4-7) and ultra-short-chain PFASs (with chain lengths of 1-3) have been extensively produced and used as substitutes. However, the substitutes have also shown significant environmental persistence and have become primary pollutants in ecosystems. Ultra-short-chain PFASs, particularly the most hydrophilic ones, exhibit high mobility and accumulation in natural water bodies. Studies indicate that ultra-short-chain PFASs constitute more than 80% of the concentration of total PFAS found in drinking water and in polluted water bodies such as rivers and groundwater. The widespread presence highlights the urgent need to develop an effective method for reducing the risk of the ultra-short-chain PFASs in water sources.

An adsorption process using activated carbon is widely used to treat water contaminated with PFASs. Traditionally, active carbon is effective in adsorbing long-chain PFASs. However, the effectiveness diminishes when dealing with ultra-short-chain PFASs. Ultra-short-chain PFASs have low molecular weight and high hydrophilicity, and thus can easily pass through or escape the adsorption by the conventional activated carbon processes. In response to these challenges, researchers have been exploring new adsorption materials specifically designed to target and remove the short-chain PFASs effectively. For example, Chinese Patent Publication No. CN106220786A discloses a dual-functional monomer molecularly imprinted polymer for selectively adsorbing and removing PFOA and PFOS, but further research and testing are needed to establish whether the dual-functional molecularly monomer imprinted polymer can efficiently adsorb the ultra-short-chain PFASs (C₁₋₃). Similarly, Patent CN116143221A discloses modified activated carbon for removing short-chain PFASs (C₄₋₆); however, the disclosure does not provide information for effectively removing the ultra-short-chain PFASs. Additionally, current adsorption materials lack effective regeneration methods. The used adsorption materials could potentially lead to secondary pollution, as the captured PFASs might be released back into the environment during disposal or if the material degrade. Given the issue, there is an urgent need to address the persistent pollution crisis caused by the ultra-short-chain PFASs in water sources. Specifically, the development of an adsorption-regeneration process is essential.

### SUMMARY

To achieve the aforesaid objective, the disclosure provides a method for reducing the risk of ultra-short-chain per- and polyfluoroalkyl substances (PFASs) in water.

The method comprises:
1) measuring concentrations of long-chain PFASs, short-chain PFASs, and ultra-short-chain PFASs separately in target water;
2) calculating a first ratio and a second ratio; and selecting, based on the first ratio and the second ratio, Beta zeolite with a silicon-to-aluminum ratio; where, the first ratio is a ratio of the concentration of the long-chain PFASs to a combined concentration of the short-chain PFASs and the ultra-short-chain PFASs; and the second ratio is a ratio of the concentration of the short-chain PFASs to the concentration of the ultra-short-chain PFASs;
3) cyclically adsorbing and removing, using the selected Beta zeolite, the ultra-short-chain PFASs from the target water.

In the disclosure, the Beta zeolite is used to adsorb the ultra-short-chain PFASs, and is then regenerated by removing hydroxyl groups from the surface of the Beta zeolit. The regeneration causes the adsorbed ultra-short-chain PFASs to desorb, restoring the adsorption capacity of the Beta zeolite. The adsorption and regeneration process prevent the ultra-short-chain PFASs from persisting and accumulating in the environment.

In a class of this embodiment, the long-chain PFASs have carbon chains with lengths of C₈ to C₁₂; the short-chain PFASs have carbon chains with lengths of C₄ to C₇; and the ultra-short-chain PFASs have carbon chains with lengths of C₁ to C₃.

In a class of this embodiment, in 2), selecting Beta zeolite with a silicon-to-aluminum ratio is carried out as follows:
when the first ratio is ≥1.5, Beta zeolite with a silicon-to-aluminum ratio of greater than 600 is selected;
when the first ratio is <1.5 and the second ratio is ≥0.9, Beta zeolite with a silicon-to-aluminum ratio of 200-600 is selected; and
when the first ratio is <1.5 and the second ratio is <0.9, Beta zeolite with a silicon-to-aluminum ratio of 150-200 is selected.

Theoretical and experimental studies show that the Beta zeolite with a suitable silicon-to-aluminum ratio is efficient in removing the ultra-short-chain PFASs without compromising the ability of the Beta zeolite to absorb the PFASs of other chain-lengths.

In a class of this embodiment, in 3), cyclically adsorbing and removing, using the selected Beta zeolite, the ultra-short-chain PFASs from the target water comprises:
3.1) calcining the selected Beta zeolite; filling the calcined Beta zeolite with water vapor; and adsorbing, using the vapor-filled Beta zeolite, the ultra-short-chain PFASs from the target water; and
3.2) re-calcining the Beta zeolite with adsorbed ultra-short-chain PFASs, and repeating 3.1) for cyclic adsorption treatment.

The Beta zeolite has pores with inner surfaces that are suitable for trapping water molecules. In the adsorption stage, the inner surfaces of the pores and the trapped water molecules form strong interaction, such as van der Waals forces and hydrogen bonds, with C-F chain and hydrophilic functional groups of the ultra-short-chain PFASs. The interaction helps the Beta zeolite effectively capture and retain the ultra-short-chain PFASs. During the regeneration stage, calcination is used to remove the hydroxyl groups from the surface of the selected Beta zeolite, facilitating the desorption and degradation of previously absorbed ultra-short-chain PFASs from the selected Beta zeolite. The calcination process ensures that the surface of the Beta zeolite is clean and prepared for new adsorption cycles.

In a class of this embodiment, in 3.1), the selected Beta zeolite is calcined at 700-900° C. in an air atmosphere for 4-8 h.

In a class of this embodiment, in 3.1), filling the calcined Beta zeolite with water vapor comprises:
placing the calcined Beta zeolite in a closed environment with 60-70% humidity at room temperature for 2-6 h; increasing the humidity to 90-100% and placing the calcined Beta zeolite in the closed environment at room temperature for 36-48 h; and resting the Beta zeolite in water at a volume ratio of between 1:0.5 and 1:1 for 12-18 h.

In a class of this embodiment, adsorbing, using the vapor-filled Beta zeolite, the ultra-short-chain PFASs from the target water comprises:

placing the Beta zeolite filled with water vapor in an adsorption column comprising an adsorption layer; pretreating the target water and passing the pretreated target water through the adsorption layer; controlling an empty-bed residence time of the target water to be between 10 to 30 min; and measuring an effluent out of the adsorption layer; where, when a concentration of total PFASs in the effluent reaches 80% of the concentration in the target water, proceed to next step to re-calcine the Beta zeolite.

In a class of this embodiment, the pretreated target water contains soluble organic matter with a concentration of equal to or less than 10 mg/L; a turbidity of the pretreated target water is equal to or less than 10 NTU; and the concentration of the total PFASs in the pretreated target water is less than 10 μg/L.

In a class of this embodiment, the concentration of the total PFASs is a sum of concentrations of the long-chain PFASs, the short-chain PFASs, and the ultra-short-chain PFASs.

In a class of this embodiment, the target water is selected from at least one of micropolluted water bodies and drinking water.

The following advantages are associated with the disclosure:
1. The disclosure cyclically removes the ultra-short-chain PFASs from the target water using the Beta zeolite, reducing the health and environmental risks of the ultra-short-chain PFASs and preventing the PFASs from accumulating in the environment.
2. The disclosure enhances the specific adsorption capacity of the Beta zeolite for the ultra-short-chain PFASs without affecting the efficiency of removing other chain-length PFASs. The enhancement reduces the negative effects of competitive adsorption, where different substances compete for adsorption sites on the Beta zeolite.
3. The disclosure is a reagent-free, low-cost technical method that uses only water and heat, thereby eliminating the risk of secondary pollution. Compared to the conventional processes, the method offers cost-effectiveness advantages and has greater potential for widespread adoption and application in treating PFAS-contaminated water sources.

### BRIEF DESCRIPTION OF THE DRAWINGS

The disclosure is described hereinbelow with reference to accompanying drawings, in which the sole FIGURE is a flow chart of a method for removing ultra-short chain per- and polyfluoroalkyl substances (PFASs) from water of the disclosure.

### DETAILED DESCRIPTION

To further illustrate the disclosure, embodiments detailing the method for removing the ultra-short chain PFASs from the water are described below. It should be noted that the following embodiments are intended to describe and not to limit the disclosure.

### Example 1

Tap water was collected from a household faucet and had the following characteristics: a pH of 7.1, an average dissolved organic compound concentration of 0.9 mg/L, a permanganate index of 2.1 mg/L, a nitrite concentration of 0.2 mg/L, and a turbidity of 0.5 NTU. To stimulate contaminated drinking water, PFASs with different chain lengths were added to the tap water. After the addition, the concentrations of PFASs in the contaminated tap water were as follows: the ultra-short-chain (C₁₋₃) PFASs had an average concentration of 1032 ng/L; the short-chain (C₄₋₇) PFASs had an average concentration of 752 ng/L; and the long-chain (C₈₋₁₂) PFASs had an average concentration of 420 ng/L.

The ultra-short-chain PFASs was removed from the contaminated tap water according to the disclosed method, depicted in the sole FIGURE:
1. the concentrations of the long-chain PFASs, the short-chain PFASs, and the ultra-short-chain PFASs in the contaminated tap water were measured and found to be 1032 ng/L, 752 ng/L, and 420 ng/L, respectively; the three concentrations were respectively denoted as C_{long chain}, C_{short chain}, and C_{ultra-short chain};
2. a first ratio and a second ratio were calculated; where, the first ratio was 0.24, which was a ratio of C_{long chain} to a combination of C_{short chain} and C_{ultra-short chain}; the second ratio was 0.73, which was a ratio of C_{short chain} to C_{ultra-short chain}, based on the first ratio <1.5 and the second ratio <0.9, the Beta zeolite with a silica-alumina ratio of 150 was selected;
3. the ultra-short-chain PFASs were cyclically adsorbed from the contaminated tap water using the selected Beta zeolite; specifically,
A). the selected Beta zeolite was calcined at 900° C. in an air atmosphere for 8 h, so as to remove the hydroxyl groups from the surface of the selected Beta zeolite;
B). the calcined Beta zeolite was placed in a closed environment with 60%-70% humidity at room temperature for 6 h; the environmental humidity was then increased to 90%-100% at room temperature for 48 h; and the Beta zeolite was allowed to stand in water at a volume ratio of 1:1 for 18 h, so that the pores and surface of the Beta zeolite were thoroughly filled with water vapor; and
C). the vapor-filled Beta zeolite was placed in an adsorption column comprising an adsorption layer; the contaminated tap water was passed through the adsorption layer, so that the ultra-short-chain PFASs in the contaminated tap water were adsorbed onto the surface of the vapor-filled Beta zeolite.

No pretreatment was required before using the contaminated tap water, as the contaminated tap water contained 0.9 mg/L dissolved organic compounds, which was below the thread of 10 mg/L, a turbidity of 0.5 NTU, which was below the thread of 10 NTU, and 2.2 μg/L total PFASs, which was below the thread of 10 μg/L. The contaminated tap water passed through the adsorption layer and an effluent was collected. A duration for which the contaminated tap water remained in contact with the Beta zeolite was controlled to be 30 min. When the concentration of the total PFASs in the effluent reached 80% of the concentration in the contaminated tap water, the Beta zeolite was re-calcined at 900° C. in an air atmosphere for 8 h. The calcination treatment restored the hydroxyl groups on the surface of the Beta zeolite. The hydroxyl groups were essential for the regeneration of the Beta zeolite.

TABLE 1
Results of removal of PFASs using the adsorption column in Example 1

| | | Ultra-short- | Short-chain | Long-chain | Total |
|---|---|---|---|---|---|
| | Treatment | chain PFASs | PFASs | PFASs | PFASs |
| Parameter | Volume (BV) | (ng/L) | (ng/L) | (ng/L) | (ng/L) |
| Example 1 | 52000 | 325 | 137 | 22 | 484 |
| Control Group | 6800 | 431 | 212 | 26 | 669 |

Table 1 shows the treatment volume of the contaminated tap water and the concentrations of the ultra-short-chain PFASs, the short-chain PFASs, the long-chain PFASs, and the total PFASs in the effluent. For comparison, activated carbon was used as a control group, replacing the Beta zeolite. The control group was operated under the same conditions as the Beta zeolite in the adsorption column. The disclosed method treated a total volume of 52,000 bed volumes (BV) of the contaminated tap water using the adsorption column containing the Beta zeolite. The concentrations of various PFASs in the effluent were measured, and the results were as follows: an average concentration of the ultra-short-chain PFASs in the effluent was 325 ng/L; an average concentration of the short-chain PFASs in the effluent was 137 ng/L; an average concentration of the long-chain PFASs in the effluent was 22 ng/L; and an average concentration of the total PFASs in the effluent was 484 ng/L. A health risk index was calculated for the PFASs present in the contaminated tap water. Before adsorption, the health risk index was 12.56, and after adsorption using the disclosed method, the health risk index decreased to 0.75. The value of the health risk index below 1 indicated that the effluent contains a total PFAS concentration that posed no significant risk to consumers. The results of the adsorption process meet the EU health limit, which stipulates that the concentration of the total PFASs in drinking water should be below 500 ng/L. Conventional adsorption process using activated carbon treated a volume of 6800 BV of the contaminated tap water and resulted in a total PFAS concentration of 669 ng/L in the effluent. In contrast, the disclosed method was superior to the conventional adsorption process in terms of both the treatment volume of the contaminated tap water and the removal efficiency of the ultra-short-chain PFASs, without affecting the adsorption efficiency for the PFASs with other chain lengths.

### Example 2

Example 2 was similar to Example 1, except that the Beta zeolite from Example 1 was regenerated. Specifically, the steps (B) and (C) were repeated to cyclically adsorb the ultra-short-chain PFASs from the contaminated tap water. The Beta zeolite was used for two cycles.

TABLE 2
Results of removal of PFASs using the adsorption column in Example 2

| | | Ultra-short- | Short-chain | Long-chain | Total |
|---|---|---|---|---|---|
| | Treatment | chain PFASs | PFASs | PFASs | PFASs |
| Parameter | Volume (BV) | (ng/L) | (ng/L) | (ng/L) | (ng/L) |
| Cycle 1 | 51600 | 315 | 129 | 20 | 464 |
| Cycle 2 | 49800 | 335 | 134 | 12 | 481 |

Table 2 shows the results on the adsorption process over two cycles, detailing the treatment volume of the contaminated tap water and the concentrations of the ultra-short-chain PFASs, the short-chain PFASs, the long-chain PFASs, and the total PFASs in the effluent. The treatment volume decreases by approximately 5% over two cycles, with no significant change in concentrations of the ultra-short-chain PFASs, the short-chain PFASs, and the long-chain PFASs in the effluent. The health risk index remains at 0.46-0.69, below the thread of 1, indicating a risk-free level. Furthermore, the concentration of the total PFASs in the effluent meets the EU health limit for drinking water. The results demonstrate that the disclosed method exhibit cyclic regeneration performance, reducing operational costs while preventing the PFASs from persisting and accumulating in the environment.

### Example 3

River water was collected and had the following characteristics: a pH of 7.8, an average dissolved organic compound concentration of 9.7 mg/L, a turbidity of 12 NTU, and chemical oxygen demand (COD) of 23.1 mg/L, and a nitrite concentration of 0.7 mg/L. To stimulate contaminated river water, PFASs with different chain lengths were added to the river water. After the addition, the concentrations of PFASs in the contaminated river water were as follows: the ultra-short-chain (C1-C3) PFASs had an average concentration of 694 ng/L; the short-chain (C4-C7) PFASs had an average concentration of 831 ng/L; and the long-chain (C8-C12) PFASs had an average concentration of 221 ng/L.

The ultra-short-chain PFASs was removed from the contaminated river water according to the disclosed method
1. the concentrations of the long-chain PFASs, the short-chain PFASs, and the ultra-short-chain PFASs in the contaminated river water were measured and found to be 694 ng/L, 831 ng/L, and 221 ng/L, respectively; the three concentrations were respectively denoted as C_{long chain}, C_{short chain}, and C_{ultra-short chain},
2. a first ratio and a second ratio were calculated; where, the first ratio was 0.14, which was a ratio of C_{long chain} to a combination of C_{short chain} and C_{ultra-short chain}; the second ratio was 1.2, which was a ratio of C_{short chain} to C_{ultra-short chain}; based on the first ratio <1.5 and the second ratio <0.9, the Beta zeolite with a silica-alumina ratio of 400 was selected;
3. the ultra-short-chain PFASs were cyclically adsorbed from the contaminated river water using the selected Beta zeolite; specifically,
A). the selected Beta zeolite was calcined at 700° C. in an air atmosphere for 4 h, so as to remove the hydroxyl groups from the surface of the selected Beta zeolite;
B). the calcined Beta zeolite was placed in a closed environment with 60%-70% humidity at room temperature for 2 h; the environmental humidity was then increased to 90%-100% at room temperature for 36 h; and the Beta zeolite was allowed to stand in water at a volume ratio of 1:0.5 for 12 h, so that the pores and surface of the Beta zeolite were thoroughly filled with water vapor; and
C). the vapor-filled Beta zeolite was placed in an adsorption column comprising an adsorption layer; the contaminated river water was pretreated and passed through the adsorption layer containing the vapor-filled Beta zeolite, so that the ultra-short-chain PFASs present in the contaminated river water were adsorbed onto the surface of the vapor-filled Beta zeolite.

The contaminated river water was pretreated with sand filtration, as the contaminated river water contained 9.7 mg/L dissolved organic compounds, which was below the thread of 10 mg/L, a turbidity of 12 NTU, which was below the thread of 10 NTU, and 1.7 μg/L total PFASs, which was below the thread of 10 μg/L. The contaminated river water passed through the adsorption layer and an effluent was collected. A duration for which the contaminated river water remained in contact with the Beta zeolite was controlled to be 10 min. When the concentration of the total PFASs in the effluent reached 80% of the concentration in the contaminated river water, the Beta zeolite was re-calcined at 700° C. in an air atmosphere for 4 h. The calcination treatment restored the hydroxyl groups on the surface of the Beta zeolite. The hydroxyl groups were essential for the regeneration of the Beta zeolite.

TABLE 3
Results of removal of PFASs using the adsorption column in Example 3

| | | Ultra-short- | Short-chain | Long-chain | Total |
|---|---|---|---|---|---|
| | Treatment | chain PFASs | PFASs | PFASs | PFASs |
| Parameter | Volume (BV) | (ng/L) | (ng/L) | (ng/L) | (ng/L) |
| Example 2 | 33000 | 386 | 317 | 36 | 739 |
| Control Group | 5000 | 410 | 425 | 43 | 878 |

Table 3 shows the treatment volume of the contaminated river water and the concentrations of the ultra-short-chain PFASs, the short-chain PFASs, the long-chain PFASs, and the total PFASs in the effluent. For comparison, activated carbon was used as a control group, replacing the Beta zeolite. The control group was operated under the same conditions as the Beta zeolite in the adsorption column. The disclosed method treated a total volume of 33,000 BV of the contaminated river water using the adsorption column containing the Beta zeolite, the concentrations of various PFASs in the effluent were measured. The results were as follows: an average concentration of the ultra-short-chain PFASs in the effluent was 386 ng/L; an average concentration of the short-chain PFASs in the effluent was 317 ng/L; an average concentration of the long-chain PFASs in the effluent was 36 ng/L; and an average concentration of the total PFASs in the effluent was 739 ng/L. Environmental risk entropy was calculated to assess the risk posed by the PFASs present in both the contaminated river water and the effluent. Before adsorption, the environmental risk entropy was 0.126 (with a specific range of 0.1-1), and after adsorption using the disclosed method, the environmental risk entropy decreased to 0.0401 (with a specific range of 0.01-0.1), indicating a significant decrease in the total PFAS concentration. Conventional adsorption process using activated carbon treated a volume of 5000 BV of the contaminated river water and resulted in a total PFAS concentration of 878 ng/L in the effluent. In contrast, the disclosed method was superior to the conventional adsorption process in terms of both the treatment volume of the contaminated river water and the removal efficiency of the ultra-short-chain PFASs, without affecting the adsorption efficiency for the PFASs with other chain lengths.

It will be obvious to those skilled in the art that changes and modifications may be made, and therefore, the aim in the appended claims is to cover all such changes and modifications.

What is claimed is:

1. A method, comprising:
1) measuring concentrations of long-chain per- and polyfluoroalkyl substances (PFASs), short-chain PFASs, and ultra-short-chain PFASs separately in target water;
2) calculating a first ratio and a second ratio; and selecting, based on the first ratio and the second ratio, Beta zeolite with a silicon-to-aluminum ratio; wherein, the first ratio is a ratio of a concentration of the long-chain PFASs to a combined concentration of the short-chain PFASs and the ultra-short-chain PFASs; and the second ratio is a ratio of the concentration of the short-chain PFASs to the concentration of the ultra-short-chain PFASs; and
3) cyclically adsorbing and removing, using the selected Beta zeolite, the ultra-short-chain PFASs from the target water.

2. The method of claim 1, wherein the long-chain PFASs have carbon chains with lengths of C₈ to C₁₂; the short-chain PFASs have carbon chains with lengths of C₄ to C₇; and the ultra-short-chain PFASs have carbon chains with lengths of C₁ to C₃.

3. The method of claim 1, wherein in 2), selecting Beta zeolite with a silicon-to-aluminum ratio is carried out as follows:
when the first ratio is ≥1.5, Beta zeolite with a silicon-to-aluminum ratio of greater than 600 is selected;
when the first ratio is <1.5 and the second ratio is ≥0.9, Beta zeolite with a silicon-to-aluminum ratio of 200-600 is selected; and
when the first ratio is <1.5 and the second ratio is <0.9, Beta zeolite with a silicon-to-aluminum ratio of 150-200 is selected.

4. The method of claim 1, wherein in 3), cyclically adsorbing and removing, using the selected Beta zeolite, the ultra-short-chain PFASs from the target water comprises:
3.1) calcining the selected Beta zeolite; filling the calcined Beta zeolite with water vapor; and adsorbing, using the vapor-filled Beta zeolite, the ultra-short-chain PFASs from the target water; and
3.2) re-calcining the Beta zeolite with adsorbed ultra-short-chain PFASs, and repeating 3.1) for cyclic adsorption treatment.

5. The method of claim 4, wherein in 3.1), the selected Beta zeolite is calcined at 700-900° C. in an air atmosphere for 4-8 h.

6. The method of claim 4, wherein in 3.1), filling the calcined Beta zeolite with water vapor comprises: placing the calcined Beta zeolite in a closed environment with 60-70% humidity at room temperature for 2-6 h; increasing the humidity to 90-100% and placing the calcined Beta zeolite in the closed environment at room temperature for 36-48 h; and resting the Beta zeolite in water at a volume ratio of between 1:0.5 and 1:1 for 12-18 h.

7. The method of claim 4, wherein in 3.1), adsorbing, using the vapor-filled Beta zeolite, the ultra-short-chain PFASs from the target water comprises:
placing the Beta zeolite filled with water vapor in an adsorption column comprising an adsorption layer; pretreating the target water and passing the pretreated target water through the adsorption layer; controlling an empty-bed residence time of the target water to be between 10 to 30 min; and measuring an effluent out of the adsorption layer; where, when a concentration of total PFASs in the effluent reaches 80% of the concentration in the target water, proceed to next step to re-calcine the Beta zeolite.

8. The method of claim 7, wherein the pretreated target water contains soluble organic matter with a concentration of equal to or less than 10 mg/L; a turbidity of the pretreated target water is equal to or less than 10 NTU; and the concentration of the total PFASs in the pretreated target water is less than 10 μg/L.

9. The method of claim 7, wherein the concentration of the total PFASs is a sum of concentrations of the long-chain PFASs, the short-chain PFASs, and the ultra-short-chain PFASs.

10. The method of claim 1, wherein the target water is selected from at least one of micropolluted water bodies and drinking water.
